(19) United States
(12) Patent Application Publication
(10) Pub. No.: US 2007/0005668 A1
(43) Pub. Date: Jan. 4, 2007

(54) SYSTEM FOR SECURITY MANAGEMENT OF A SERVER

(75) Inventors: Pu-Yang Yeh, TUCHENG (TW); Zhun Xiao, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,578

(22) Filed: Apr. 8, 2006

(30) Foreign Application Priority Data
Jul. 2, 2005 (CN) 200510035777.2

(51) Int. Cl. G06F 17/30

(52) U.S. Cl. 707/204

(57) ABSTRACT

A system for security management of a server is disclosed. The system includes an application server (1), at least a LAN server (2), a firewall (3), and a connection to the Internet (4). The LAN server is capable of updating the application server automatically and periodically so as to improve protection against the latest viruses. The application server includes a database (20), a database backup module (30), a database recovery module (40) and a file management module (50). By using this system, the application server is able to be upgraded automatically and securely, and the backup and recovery of database could be realized steadily and swiftly. Therefore, the security management of all files is achieved.

### FIELD OF THE INVENTION

The present invention generally relates to systems for server management, and more particularly to a system for security management of a server.

### DESCRIPTION OF RELATED ART

A database system is very important in today's world. A database is essentially a collection of information that can be queried for desired information by a computer operator. Database security is a growing concern for many enterprises; incidents of data misuse and theft are increasing, and recent regulations have mandated strict requirements for data security, data privacy, and data integrity. Generally speaking, most information (such as customer data, production data, and the likes) in a database is stored in an application server of an enterprise and may not have any hard-copy back-ups. Therefore, security related to databases and data stored therein is a growing importance. Moreover, many present database security techniques can be breached through Trojan Horse and/or by software hackers with malicious intent, because they do not provide a good enough comprehensive level of security.

Commonly, an application server is installed between the Internet and the server group of an enterprise. Any application server connected to the Internet without a firewall can be hijacked in just a few minutes by an automated hacker program such as “Bots”. The only way to make the application server 100% secure is to turn it off or disconnect it from the Internet. The real issue is how to make the application server 99% secure when it is connected. So it is necessary to install a firewall between the application server and the Internet. Though a firewall may provide adequate protection by making it difficult for the “outlaws” (hackers) to identify and take control of the application server, data in the application server may be affected because the application server may not have the capability of updating itself in a timely manner. In addition, performing a database back-up is another important strategy to ensure the security of the data. However, most database backup function cannot be performed while the database is in use.

Therefore, what is needed is a system for security management of a server, which can accomplish upgrading for a server automatically and securely, and also can realize backup and recovery of database steadily and swiftly.

### SUMMARY OF INVENTION

One embodiment of the present invention provides a system for security management of a server. The system includes an application server, at least a LAN server, a firewall, and a connection to the Internet. The application server includes a database, a database backup module, a database recovery module, and a file management module. The database is used for storing different kinds of data. The database backup module is used for generating a back-up of the database, and storing the generated backed-up database in a data storage device. The database recovery module is used for recovering data from the data storage device into the database. The file management module is used for managing and controlling all files in the application server.

Other objects, advantages and novel features of the embodiments will be drawn from the following detailed description together with the attached drawings, in which:

### BRIEF DESCRIPTION OF DRAWINGS

FIG. 1 is a schematic diagram of a hardware configuration and application environment of a system for security management of a server in accordance with a preferred embodiment;

FIG. 2 is a schematic diagram of main function modules of an application server of the system of FIG. 1;

FIG. 3 is a schematic diagram illustrating data flow of the system of FIG. 1;

FIG. 4 is a flow chart of a method for backing-up data automatically; and

FIG. 5 is a flow chart of a method for recovering data automatically.

### DETAILED DESCRIPTION

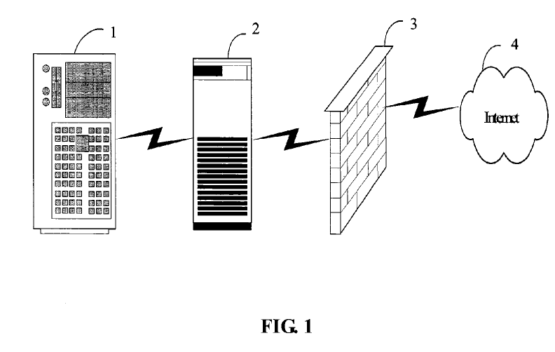

FIG. 1 is a schematic diagram of a hardware configuration and application environment of a system for security management of a server (hereinafter, “the system”), in accordance with a preferred embodiment. In the preferred embodiment, the system typically includes an application server 1, at least a Local Area Network (LAN) server 2, a firewall 3, and a connection to the Internet 4. The application server 1 is indirectly connected with the Internet 4 through the firewall 3, because the LAN server 2 is sequentially connected between the application server 1 and the firewall 3. The LAN server 2 is capable of updating the application server 1 automatically and periodically so as to improve protection against the latest viruses when the firewall 3 is invaded by unsafe factors, such as viruses and the likes.

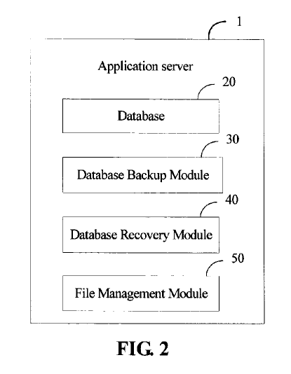

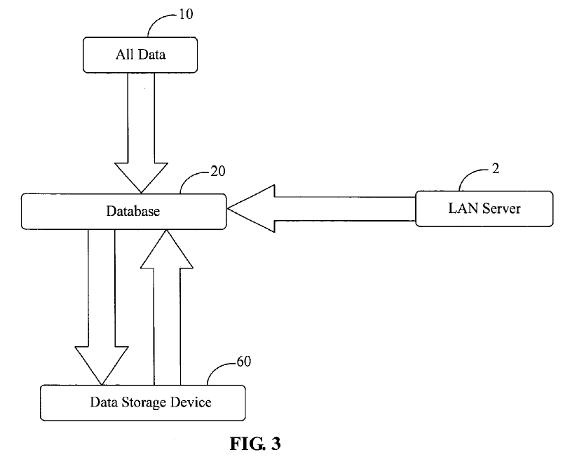

FIG. 2 is a schematic diagram of main function modules of the application server 1 of the system. The application server 1 includes a database 20, a database backup module 30, a database recovery module 40, and a file management module 50. The database 20 is used for storing different kinds of data, including customer data, production data, design data, and the likes. The database backup module 30 is used for performing an automatic back-up of the database 20 after a predetermined period time via disk operating system (DOS). Specifically, the database backup module 30 generates a back-up of the database 20, and stores the generated backed-up database in a data storage device 60 (shown in FIG. 3), which may be installed in any security server of an Intranet. The database recovery module 40 is used for recovering data from the data storage device 60 into the database 20 via DOS automatically. The file management module 50 is used for managing all files in the application server 1, including setting up sharing attributes, access authorization for different users, and disk quota. For example, system administrators may be granted with full authorization to the files while common users may only have the authorization of reading files only.

FIG. 3 is a schematic diagram illustrating data flow of the system. Firstly, all kinds of data in different departments are pigeonholed and stored in the database 20, the database backup module 30 generates a back-up of the database 20 via DOS automatically after a predetermined period time and stores the generated backed-up database in the data storage device 60. When a user can't access particular data within his access authorizations, or the integrity of the data that the user accesses is violated, the recovery module 40 recovers data from the data storage device 60 into the database 20 via DOS automatically. The LAN server 2 is capable of loading and installing software patches, and periodically updating the application server 1, so that the application server 1 is able to be upgraded automatically and securely, and the backup and recovery of the database 20 could be realized steadily and swiftly.

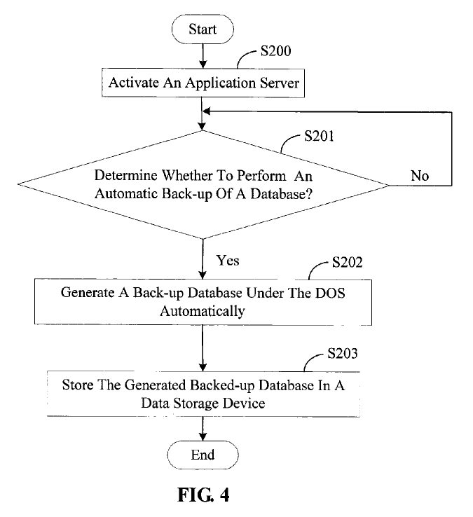

FIG. 4 is a flow chart of a method for backing-up data automatically. In step S200, the application server 1 is activated. In step S201, the database backup module 30 determines whether to perform an automatic back-up of the database 20. Otherwise, the procedure returns to step S201. If it is determined to perform an automatic back-up of the database 20, in step S202, the database backup module 30 generates a back-up database via DOS automatically. In step S203, the database backup module 30 stores the generated backed-up database in the data storage device 60.

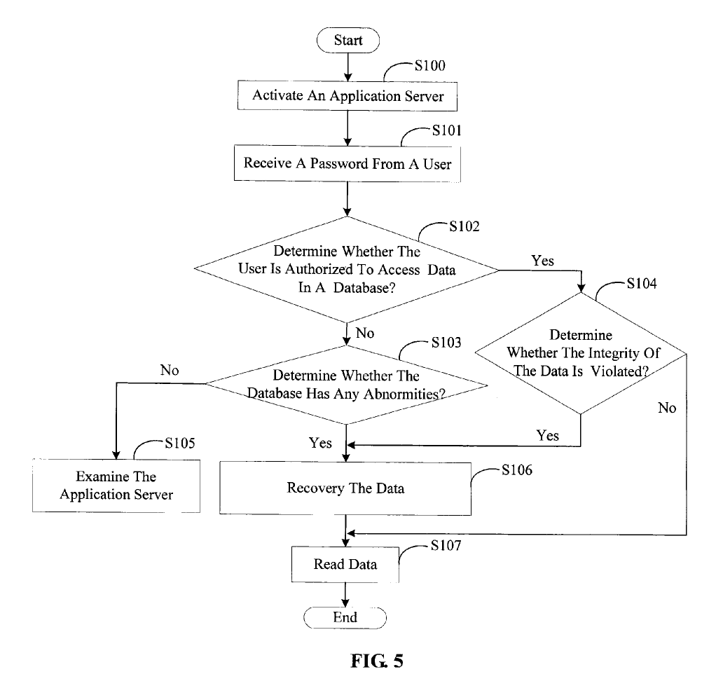

FIG. 5 is a flow chart of a method for recovering data automatically. In step S100, the application server 1 is activated. In step S101, the application server 1 receives a password from a user. In step S102, the application server 1 determines whether the user is authorized to access data in the database 20 within the user's access authorizations. If the user is not authorized, in step S103, the database 20 may perform an automatic scan to determine whether the database 20 has any abnormities. If the database 20 does not has any abnormities, in step S105, administrators of the application server 1 are informed to examine the application server 1 and to do corresponding follow ups. If in step S102, the user is authorized to access the data in the database 20, in step S104, the application server 1 determines whether the integrity of the data that the user accesses is violated. If the database 20 has any abnormities in step S103 or the integrity of the data that the user accesses is violated in step S104, in step S106 the database recovery module 40 recovers the data from the data storage device 60 into the database 20 via DOS automatically. In step S107, the user reads data in the database 20. If the integrity of the data that the user accesses is not violated in step S104, the procedure goes to step S107 directly.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for security management of a server, the system comprising an application server, at least a LAN server, a firewall and a connection to the Internet, the application server comprising:
a database for storing different kinds of data;
a database backup module for generating a back-up of the database and storing the generated backed-up database in a data storage device;
a database recovery module for recovering data from the data storage device into the database; and
a file management module for managing and controlling all files in the application server.

2. The system according to claim 1, wherein the database backup module is further used for:
activating the application server;
determining whether to perform an automatic back-up of the database;
generating a back-up of the database; and
storing the generated backed-up database in the data storage device.

3. The system according to claim 1, wherein the data recovery module is further used for:
activating the application server;
receiving a password from a user;
determining whether the user is authorized to access the database according to a user's authorization account;
determining whether the database has any abnormities if the user is not authorized to access the database;
recovering data from the data storage device into the database if the database has any abnormities; and
reading data in the database.

4. The system according to claim 3, wherein the data recovery module is further used for:
determining whether the integrity of the data that the user accesses is violated if the user is authorized to access the database;
recovering the data from the data storage device into the database if the integrity of the data that the user accesses is violated; and
reading data in the database.

5. The system according to claim 1, wherein the file management module is further used for setting up sharing attributes, access authorization for different users and disk quota.
